(19) United States
(12) Patent Application Publication
(10) Pub. No.: US 2025/0364827 A1
(43) Pub. Date: Nov. 27, 2025

(54) VOLTAGE-CONFIGURABLE RECHARGEABLE BATTERY DEVICE AND CHARGING TERMINAL AND CHARGING STATION

(71) Applicant: ETRONTA LIMITED, HK (CN)

(72) Inventor: BINBO WU, Tianmen (CN)

(21) Appl. No.: 18/673,640

(22) Filed: May 24, 2024

(51) Int. Cl. H02J 7/00; A63F 13/24; H01M 10/42; H01M 10/48; H01M 50/202; H01M 50/247; H01M 50/296; H02J 50/10; H02J 50/80

(52) U.S. Cl. CPC H02J 7/007182; A63F 13/24; H01M 10/425; H01M 10/48; H01M 50/202; H01M 50/247; H01M 50/296; H02J 7/0045; H02J 7/0047; H02J 50/10; H02J 50/80; H01M 2010/4271; H01M 2220/30; H02J 2207/20

(57) ABSTRACT

The present invention discloses a voltage-configurable rechargeable battery device and charging terminal and charging station, wherein the voltage-configurable rechargeable battery device comprises a rechargeable battery, a battery voltage management circuit, and a battery capacity acquisition circuit; the rechargeable battery is electrically connected to a charging terminal; the battery voltage management circuit comprises a boost/buck management circuit; the battery capacity acquisition circuit is connected to the battery voltage management circuit; the rechargeable battery can realize discharge curve following according to the current capacity via the battery voltage management circuit. The present invention can ensure basically consistence of the actual power level and the displayed power level, and improve users' experience.

### TECHNICAL FIELD

The present invention relates to charging devices, in particular to a voltage-configurable rechargeable battery device, especially a voltage-configurable rechargeable battery device and charging terminal and charging station.

### BACKGROUND

The most common power supply for VR joystick controllers is AA/AAA dry batteries, which are not rechargeable and need to be disassembled and replaced frequently, not friendly to users and the environment. To address that, there is a solution of directly replacing it with nickel-metal hydride battery on the market. Nevertheless, in practice, the power supply of nickel-metal hydride battery mismatches with the working voltage of the joystick, resulting in wrong power information display on the corresponding host and wrong prompt of battery fault to a certain extent. Additionally, the nickel-metal hydride battery has a memory effect, and some traces will be left in the battery in case of no complete charging and discharging, reducing the battery capacity.

### SUMMARY

The technical solution of the present invention is to provide a voltage-configurable rechargeable battery device, which can solve the technical problems of inconsistence between the actual power and the real power in the prior art that leads to users' poor experience, and can achieve at least one of the technical effects, i.e. consistence between the display power and the actual power and better users' experience.

A technical solution of the present invention for solving the above technical problems is:

A voltage-configurable rechargeable battery device, comprising a rechargeable battery, a charging input module, an output electrode, and a battery voltage management circuit, wherein the rechargeable battery is electrically connected to a charging terminal, and the battery voltage management circuit comprises a boost/buck management circuit that can stabilize the voltage of the rechargeable battery at the working voltage required by a charging terminal, and output voltage through the output electrode; the discharge curve of the battery can be simulated with the aid of the battery voltage management circuit for the output voltage of the voltage-configurable rechargeable battery device.

Preferably, the voltage-configurable rechargeable battery device further comprises a battery voltage acquisition module, which is connected to the battery voltage management circuit and can adjust the output voltage to follow the changes according to the changes in the battery power supply, wherein the discharge curve of the battery may be simulated for the output voltage of the voltage-configurable rechargeable battery device with the aid of the battery voltage management circuit and the battery voltage acquisition module; the voltage management circuit is a DC management circuit, comprising at least one of battery voltage change following circuit, boost management circuit, buck management circuit, and boost/buck integrated circuit; when the rated working voltage of the terminal device is lower than that of the rechargeable battery, the boost management circuit is adopted; when the rated working voltage of the terminal device is higher than that of the rechargeable battery, the buck management circuit is adopted; when the rated working voltage of the terminal device is higher than the minimum output voltage of the rechargeable battery and is lower than the maximum output voltage of the rechargeable battery, the boost/buck integrated management circuit is adopted; the charging terminal can capture a gradual voltage drop.

Preferably, the voltage-configurable rechargeable battery device further comprises a battery capacity acquisition circuit and a reset circuit, wherein the reset circuit resets the output at the moment when the charging stops; discharge curve following can be realized according to the current capacity by using the battery voltage management circuit and the battery capacity acquisition circuit.

Preferably, the voltage-configurable rechargeable battery device further comprises a battery encapsulation enclosure, a battery charging input electrode, a positive electrode of battery device, a negative electrode of battery device, an output electrode lead, a lithium battery input/output conductor, and a battery charging conductor; the rechargeable battery is of lithium battery;

Wherein the lithium battery input conductor is used for charging;

The lithium battery supplies power to the battery voltage management circuit via the battery output conductor, the battery voltage management circuit manages the voltage output from the lithium battery, stabilizes the voltage at the rated voltage required by the charging terminal equipment through a boost/buck management circuit, supplies power to the charging terminal equipment through the positive and negative outputs of the battery device and introduces a battery capacity via the boost/buck management circuit acquisition circuit to adjust the output voltage according to the current capacity of the lithium battery and realize battery discharge curve following.

Preferably, the conductor is a lead.

Preferably, the battery charging management circuit may be integrated on the battery voltage management circuit or placed externally on the charging device.

Preferably, the enclosure of the battery encapsulation enclosure is provided with a power output electrode, wherein the power output electrode comprises an output positive electrode, an output negative electrode; the output positive electrode is located at a first end of the enclosure and at least one side of the electrode contact is exposed on the surface of the enclosure, and the output negative electrode is located at a second end of the enclosure opposite to the first end, and the electrode contacts of at least one side are exposed on the surface of the enclosure.

Preferably, the voltage-configurable rechargeable battery device further comprises a charging input module, which comprises at least one of contact electrode, USB port, and power sensing coil;

Wherein the contact electrode comprises an input positive electrode and an input negative electrode both arranged on the surface of the enclosure, and the contact electrode is connected to the rechargeable battery via a conductor;

The USB port is connected to the charging management circuit, and the charging management circuit is connected to the rechargeable battery;

The power sensing coil comprises a power receiving management circuit and is designed to receive the power transmitted by an external wireless transmitter and is connected to the power receiving management circuit, and the power receiving management circuit is connected to the rechargeable battery.

The present invention further provides a charging terminal, comprising a voltage-configurable rechargeable battery device as described in any one of the above; the charging terminal comprises a VR device.

The present invention further provides a charging station applied to the foregoing charging terminal.

Preferably, the charging station comprises:
A storage stand for receiving the VR display device;
A charging base, comprising a power input port, a power output port, and an interactive joystick controller charging part for receiving an interactive joystick and charging a rechargeable battery of the interactive joystick;
The charging base is provided with a mounting slot, the storage stand is detachably connected to the charging base, and is located above the charging base.

Preferably, the storage stand is made of light-conducting material.

Preferably, the charging terminal comprises a charging part, comprising at least one of contact electrode, USB, and power transmitting coil.

Preferably, the charging station further comprises a tail tray holder fixedly connected to the storage stand and located above the charging base.

Preferably, the tail tray is movable on the storage stand.

Preferably, the mounting slot for the charging base is provided with at least a LED, of which the emitting light may be directed into the storage stand.

One or more technical solutions provided in the present application have at least the following technical effects or advantages:

The above technical solutions can adjust the output voltage according to the current capacity of the lithium battery with the adoption of a rechargeable battery, a charging input module, an output electrode, and a battery voltage management circuit and realize the discharge curve following so as to avoid a jumping transition of the voltage at the output terminal from 100% to 0% when the lithium battery is on the verge of low-voltage protection, and finally achieve the technical effects of consistence between the displayed power and the actual power and better users' experience.

### BRIEF DESCRIPTION OF DRAWINGS

FIG. 1 is a structural diagram of the rechargeable joystick battery and device with voltage management circuit of the present invention;

FIG. 2 is an output diagram of the rechargeable joystick battery with voltage management circuit of the present invention;

FIG. 3 is a schematic diagram of the built-in battery charging circuit;

FIG. 4 is a diagram of the boost DC-DC management circuit;

FIG. 5 is a diagram of the buck DC-DC management circuit;

FIG. 6 is a diagram of the boost-buck DC-DC management circuit;

FIG. 7 is a diagram of the voltage-programmable output DC-DC management circuit;

FIG. 8 is a diagram of the rechargeable battery device with voltage management circuit and enclosure of the battery for joystick controller with battery electrode;

FIG. 9 is a mounting diagram of the rechargeable VR joystick controller;

FIG. 10 is a structural diagram of the charging station;

FIG. 11 is a schematic diagram of the rechargeable VR joystick controller and the charging station.

In the figures, 1 means battery encapsulation enclosure, 2 lithium battery, 3 battery charging input electrode, 4 positive electrode of battery device, 5 negative electrode of battery device, 6 battery voltage management circuit, 7 output electrode lead, 8 lithium battery input/output lead and 9 battery charging lead.

### DESCRIPTION OF EMBODIMENTS

The following describes the prevent invention in detail with reference to embodiments and the figures. It is noted that the following embodiments are only used to explain the prevent invention, and do not constitute a limitation on the prevent invention. Moreover, the technical features related to the embodiments of the present invention described as follows can combine with each other when they are not conflict with each other.

To make the technical solutions of the present invention more clear, the following further describes the present invention in detail with reference to the drawings of the specifications and embodiments.

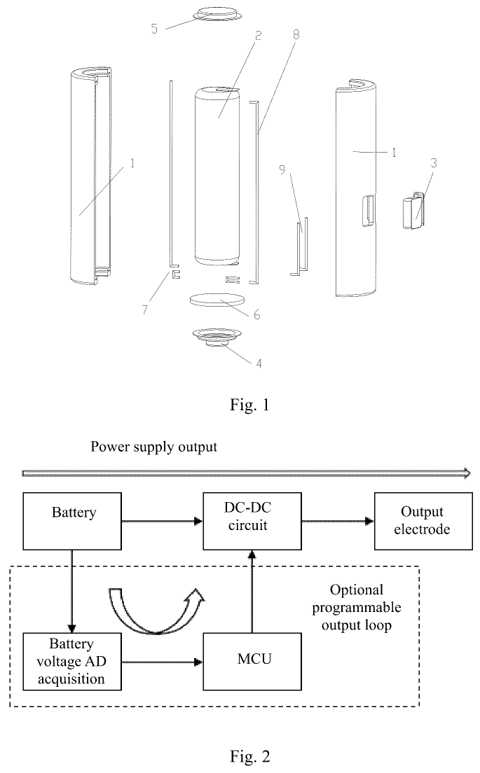

To address the defects unfriendliness of the disposable AA/AAA dry battery to users and the environment, memory characteristics of nickel-metal hydride battery, and the misleading perception of interactive experience caused by mismatching with the power display of the VR host, the present invention discloses a rechargeable battery device that output voltage can be managed, as shown in FIG. 1, which comprises 1 a battery encapsulation enclosure, 2 a lithium battery, 3 a battery charging input electrode, 4 a positive electrode of battery device, 5 a positive electrode of battery device, 6 a battery voltage management circuit, 7 an output electrode lead, 8 a lithium battery input/output lead, and 9 a battery charging lead.

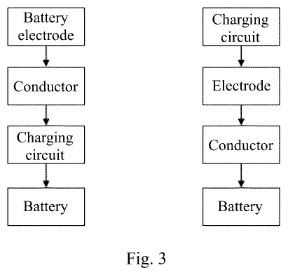

For the voltage management principle of the rechargeable battery device, the discharge process and schematic diagram, please refer to FIG. 2: lithium battery 2 supplies power to the battery voltage management circuit 6 via the battery input/output lead and the battery voltage management circuit 6 manages the voltage output from the lithium battery 2, stabilizes the voltage at the rated voltage required by such terminal equipment as VR joystick via the boost/buck management circuit, and supplies the power to such terminal equipment as VR joystick via the positive and negative electrodes of the battery device; further the boost/buck management circuit introduces into the lithium battery capacity acquisition circuit, adjusts the output voltage according to the current capacity of the lithium battery and realizes discharge curve following of the battery so as to avoid a jumping transition of the voltage at the output terminal from 100% to 0% when the lithium battery is on the verge of the low-voltage protection; for the schematic diagram of charging process, please refer to FIG. 3: The input power supply is fed to the lithium battery 2 for charging via the input charging electrode 3, charging lead 9, battery input/output lead 8, and the battery charging management circuit may be integrated on the battery voltage management circuit 6 or placed externally on the charging device.

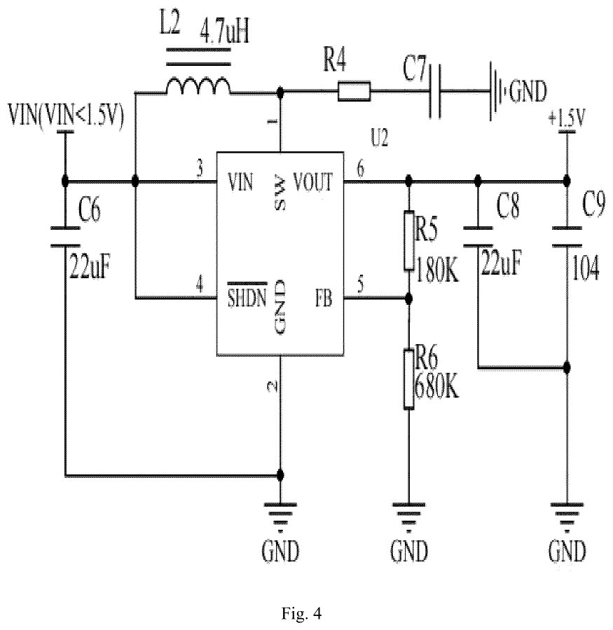

Further, with respect to the battery voltage management circuit, the present invention adopts a DC-DC boost/buck management chip to manage the output voltage of the lithium battery to meet the power supply required for the work of such terminal equipment as VR joystick controller, and when the output voltage of the lithium battery is lower than the working voltage required by the terminal equipment, the boost circuit is adopted for management. For the circuit diagram, please refer to FIG. 4. The FB pin of U2 in the circuit diagram provides a reference voltage, and the output voltage may be adjusted by means of adjusting the proportionality of the resistance values of the feedback resistors R5 and R6, and the output voltage is equal to

$$Vout = {V}_{FB \_ U 1} * \frac{R 5 + R 6}{R 6} \qquad ( 1 )$$

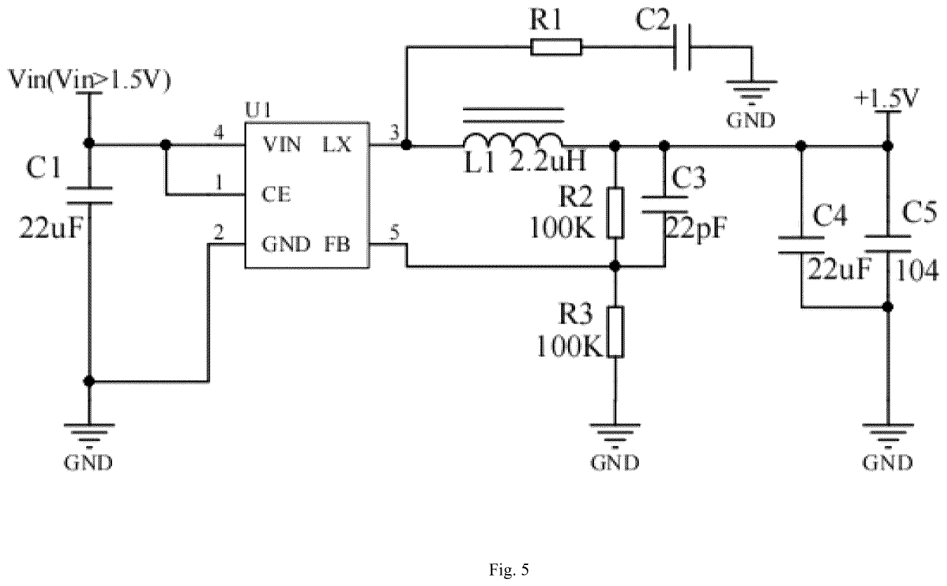

Further, when the output voltage of the lithium battery is higher than the required working voltage of the terminal equipment, the buck circuit is adopted for management. For the circuit diagram, please refer to FIG. 5. The FB pin of U2 in the circuit diagram provides a reference voltage, and the output voltage may be adjusted by means of adjusting the proportionality of the resistance values of the feedback resistors R2 and R3, and the output voltage is equal to

$$Vout = {V}_{FB \_ U 2} * \frac{R 2 + R 3}{R 3} \qquad ( 2 )$$

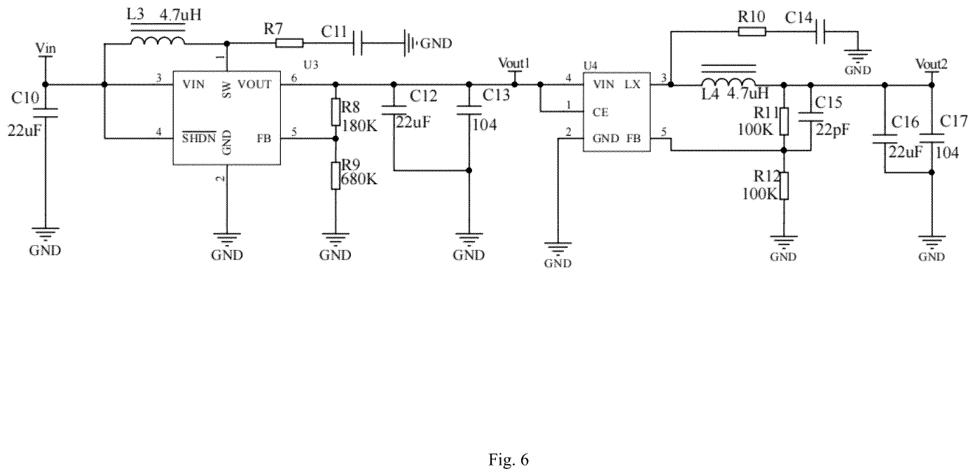

Further, when the output voltage of the lithium battery is lower or higher than the required working voltage of the terminal equipment, the management mode of first boost and then buck is adopted for the DC-DC power management circuit. For the circuit diagram, please refer to FIG. 6. The FB pin of U3 in the boost circuit provides a reference voltage, and the voltage output of Vout1 may be adjusted by means of adjusting the proportionality of the resistance values of the feedback resistors R8 and R9, as shown in Equation (3), and the FB pin of U4 in the buck circuit provides a reference voltage, and the voltage output of Vout2 may be adjusted by means of adjusting the proportionality of the resistance values of the feedback resistors R11 and R12, as shown in Equation (4), wherein Vout1>Vout2.

$$V out 1 = {V}_{FB \_ U 4} * \frac{R 8 + R 9}{R 9} \qquad ( 3 )$$

$$V out 2 = {V}_{FB \_ U 5} * \frac{R 11 + R 12}{R 2} \qquad ( 4 )$$

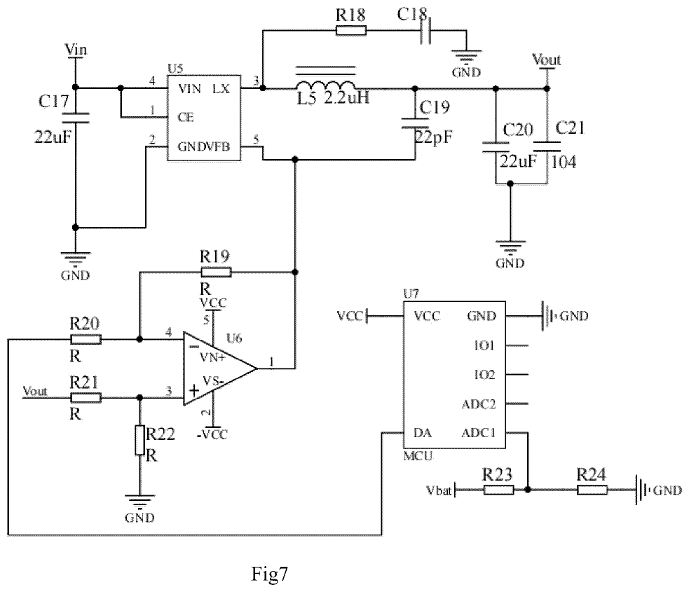

Further, the voltage of the lithium battery may be acquired by ADC circuit (the ADC acquisition circuit may also be integrated with a programmable microprocessor) by means of introducing a programmable device, and the DAC output circuit dynamically adjusts the output voltage of the DC-DC management circuit according to the voltage of the lithium battery, and changes the current parameter of the feedback resistor network of the DC-DC management circuit so as to realize automatic following of the output voltage of the battery device with the voltage change of the lithium battery. For the reference circuit, please refer to FIG. 7, and for the output voltage of DC-DC management circuit, please refer to Equation (5). When and the feedback resistors R19, R20, R21, R22 and VFB_U5 are fixed, and the DA output value is adjusted by a programmable controller U5 to control the output voltage VDA so as to adjust the output voltage Vout of DC-DC management circuit.

$$Vout = \frac{( {V}_{FB \_ U 5} * R 20 + {V}_{DA} * R 19 ) ( R 21 + R 22 )}{R 22 * ( R 20 + R 19 )} \qquad ( 3 )$$

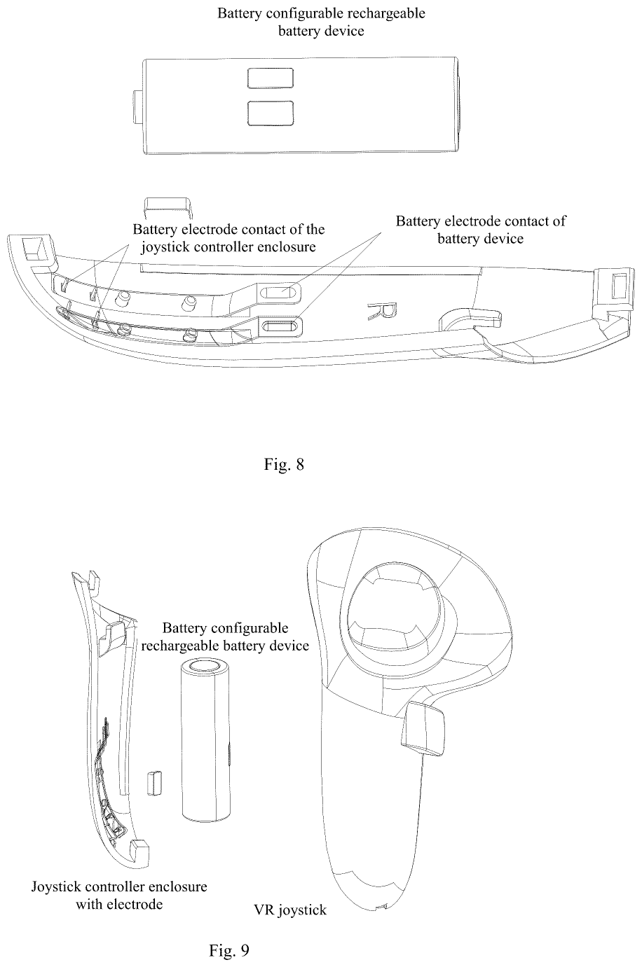

Further, the rechargeable battery device for voltage management is provided with an enclosure cover for the battery of the joystick controller with battery electrode to replace the non-chargeable VR joystick controller with a chargeable on, as shown in FIG. 8. The inner and outer surfaces of the enclosure cover for the battery of the joystick controller with battery electrode are provided with one pair of electrode contacts, wherein the electrode contacts on the outer surface are in contact with those on the inner surface to transfer the battery power to the VR joystick controller. When the enclosure cover for the battery of the joystick controller is closed, the battery electrodes on the enclosure contacts with those of the voltage-configurable rechargeable battery device to charge the lithium battery of the battery device via the enclosure contacts, as shown in FIG. 9.

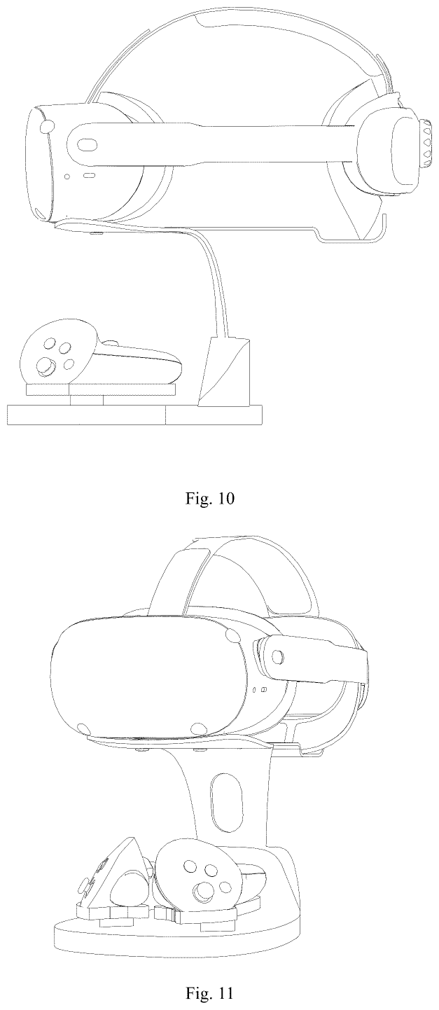

Further, the rechargeable VR joystick controller is used with a charging station (see FIG. 10) (the schematic diagram for application is shown in FIG. 11), wherein the charging station comprises: a storage light-conducting stand, a tail tray and a charging base; the storage light-conducting stand, made of light-conducting material, is designed to store the VR host and detachably connected to the charging base, with its upper plane being parallel to the charging base; the tail tray is detachably connected to the storage light-conducting stand, and may be moved forward and back; the charging base comprises:
A power input port: for supplying power to the charging base.
A joystick controller charging part: designed for charging the rechargeable VR joystick controller, and provided with a VR joystick controller charging contact connected to an external rechargeable electrode of the VR joystick controller arranged in the charging part.
At least one LED: the LED is mounted on the charging base corresponding to the slot position of the storage light-conducting stand, and the light emitted by the LED may be directed via the storage light-conducting stand.
At least one USB charging output port: for charging such terminals as VR host.

Control circuit: comprising a lithium battery charging management circuit, an LED control circuit, a USB terminal equipment charging management circuit, wherein the lithium battery charging management circuit is designed to charge the rechargeable VR joystick controller, the USB terminal equipment management circuit is designed to charge such terminal equipment as VR host, and the LED control circuit is designed for ON/OFF and control of the LED.

The embodiments of the present invention have been described in detail above with reference to the accompanying drawings, but the present invention is not limited to the described embodiments. It will be apparent to those skilled in the art that various changes, modifications, substitutions and variations can be made in these embodiments without departing from the principles and spirit of the present invention and yet fall within the scope of the present invention.

What is claimed is:

1. A voltage-configurable rechargeable battery device for supplying power to terminal equipment, comprising a rechargeable battery, a charging input module, an output electrode, and a battery voltage management circuit, wherein the charging input module is connected the rechargeable battery to charge the rechargeable battery, the rechargeable battery is connected to the battery voltage management circuit, and the battery voltage management circuit comprises a boost/buck management circuit that can stabilize the voltage of the rechargeable battery at the working voltage required by a charging terminal, and output voltage through the output electrode.

2. The voltage-configurable rechargeable battery device according to claim 1, wherein the voltage-configurable rechargeable battery device further comprises a battery voltage acquisition module, which is connected to the battery voltage management circuit and can adjust the output voltage to follow the changes according to the changes in the battery power supply and make the output of the voltage-configurable rechargeable battery device change with the capacity change of the rechargeable battery device with the aid of the battery voltage management circuit; the voltage management circuit is a DC management circuit, comprising at least one of battery voltage change following circuit, boost management circuit, buck management circuit, and boost/buck integrated circuit; when the rated working voltage of the terminal device is lower than that of the rechargeable battery, the boost management circuit is adopted; when the rated working voltage of the terminal device is higher than that of the rechargeable battery, the buck management circuit is adopted; when the rated working voltage of the terminal device is higher than the minimum output voltage of the rechargeable battery and is lower than the maximum output voltage of the rechargeable battery, the boost/buck integrated management circuit is adopted.

3. The voltage-configurable rechargeable battery device according to claim 2, wherein the voltage management circuit further comprises an output reset circuit to conduct the operation of first turn-off and then turn-on for the output of the voltage-configurable rechargeable battery device.

4. The voltage-configurable rechargeable battery device according to claim 1, wherein the voltage-configurable rechargeable battery device further comprises a battery encapsulation enclosure, a battery charging input electrode, a positive electrode of battery device, a negative electrode of battery device, an output electrode conductor, a lithium battery input/output conductor, and a battery charging conductor; the rechargeable battery is of lithium battery;
wherein the lithium battery input conductor is used for charging;
the lithium battery supplies power to the battery voltage management circuit via the battery output conductor, the battery voltage management circuit manages the voltage output from the lithium battery, stabilizes the voltage at the rated voltage required by the charging terminal equipment through a boost/buck management circuit, supplies power to the charging terminal equipment through the positive and negative outputs of the battery device and introduces a battery capacity via the boost/buck management circuit acquisition circuit to adjust the output voltage according to the current capacity of the lithium battery and realize battery discharge curve following.

5. The voltage-configurable rechargeable battery device according to claim 1, wherein the battery charging management circuit may be integrated on the battery voltage management circuit or placed externally on the charging device.

6. The voltage-configurable rechargeable battery device according to claim 4, wherein the battery encapsulation enclosure is provided with a power output electrode, wherein the power output electrode comprises an output positive electrode, an output negative electrode; the output positive electrode is located at a first end of the enclosure and at least one side of the electrode contact is exposed on the surface of the enclosure, and the output negative electrode is located at a second end of the enclosure opposite to the first end, and the electrode contacts of at least one side are exposed on the surface of the enclosure; the enclosure is provided with magnet.

7. The voltage-configurable rechargeable battery device according to claim 4, wherein the charging input module is designed to charge the charging terminal and comprises at least one of contact electrode, USB port, and power sensing coil;
wherein the contact electrode comprises an input positive electrode and an input negative electrode both arranged on the surface of the enclosure, and the contact electrode is connected to the rechargeable battery via a conductor;
the USB port is connected to the charging management circuit, and the charging management circuit is connected to the rechargeable battery;
the power sensing coil comprises a power receiving management circuit and is designed to receive the power transmitted by an external wireless transmitter and is connected to the power receiving management circuit, and the power receiving management circuit is connected to the rechargeable battery.

8. A charging terminal, comprising a voltage-configurable rechargeable battery device as described in any one of claim 1; the charging terminal comprises a VR device.

9. A charging station applied to the foregoing charging terminal.

10. The charging station according to claim 9, wherein the charging station comprises:
a storage stand for receiving the VR display device;
a charging base, comprising a power input port, a power output port, and an interactive joystick controller charging part for receiving an interactive joystick and charging a rechargeable battery of the interactive joystick device;
the charging base is provided with a mounting slot, the storage stand is detachably connected to the charging base, and is located above the charging base.

11. The charging station according to claim 10, wherein the storage stand is made of light-conducting material.

12. The charging station according to claim 10, wherein the charging terminal comprises a charging part, comprising at least one of contact electrode, USB, and power transmitting coil.

13. The charging station according to claim 10, wherein the charging station further comprises a tail tray holder fixedly connected to the storage stand and located above the charging base.

14. The charging station according to claim 13, wherein the tail tray is movable on the storage stand.

15. The charging station according to claim 13, wherein the mounting slot for the charging base is provided with at least a LED, of which the emitting light may be directed into the storage stand.
